(19) United States
(12) Patent Application Publication
(10) Pub. No.: US 2012/0255958 A1
(43) Pub. Date: Oct. 11, 2012

(54) CONDUCTIVE TANK SUMP AND DISPENSER SUMP, AND METHOD OF EARTHING PROCESS OF THE SAME

(75) Inventors: Brian John Joseph, Melaka (MY); Kuhan Bala Subramaniam, Klang (MY)

(73) Assignee: GUARDIAN VENTURE OIL & GAS SDN BHD, Shah Alam, Selangor Darul Ehsan (MY)

(21) Appl. No.: 13/516,567

(22) PCT Filed: Dec. 15, 2009
(86) PCT No.: PCT/MY2009/000206

§ 371 Date: Jun. 15, 2012

(51) Int. Cl. B65D 90/46; B65D 88/76; H01R 43/00

(52) U.S. Cl. 220/567.1; 29/825

(57) ABSTRACT

A conductive tank sump (100) and a dispenser sump (200) ensuring dissipation of electrostatic charges is disclosed. The sumps (100, 200) which are fully conductive through underground comprising (a) a sump wall made from fiberglass composition impregnated with conductive resin; (b) a ground block (16, 26) secured at the inner surface of the sumps (100, 200); (c) a plurality of pipes mounted through holes provided on the wall of the sumps (100, 200); (d) a plurality of grounding cables (116, 226) connecting the pipes and/or isolated conductors which needs to be earthed to the ground block (16, 26) on the wall of the tank sump/dispenser sump (100, 200). The present invention also relates to method of grounding of the tank sump/dispenser sump (100, 200).

### FIELD OF THE INVENTION

This invention relates in general to fully conductive tank sumps and dispenser sumps, and more particularly to conductive tank sumps and dispenser sumps for fueling or refueling facilities (petrol stations or the like) which are mounted in the ground, and a method of earthing the tank and the dispenser sumps.

### BACKGROUND OF THE INVENTION

Tank sumps and dispenser sumps or secondary containment systems for fueling or refueling facilities are generally located below ground level and are designed to keep ground water out and to prevent hydrocarbon spillage or leakage from contaminating the environment beneath such petroleum service stations.

Tank sumps or dispenser sumps for fueling or refueling facilities have been devised to address the problems mentioned and also to solve the problem of static charge build-up on the sumps or tank surfaces in the course of maintenances or working and drilling holes on the wall of the storage tank.

Moreover the invention dissipates static charges from the gasoline pipes and or any isolated conductors via the earth block, through the tank to the ground.

Conventional tank sumps or dispenser sumps for fueling or refueling facilities are made from plastic materials such as Polyethylene (PE), Polypropylene (PP) or Fiber Reinforced Plastic (GRP/FRP). These plastic materials are non-conductive and pose hazards to static charges in a hazardous vapour environment. Technicians or servicing personnel may need to work and drill holes in the confined sumps which generally can generate static charges more than 22 Kilovolts. In the course of drilling, there is a risk to ignite petroleum vapour that is present in the tank.

Another drawback or a further hazard with conventional sumps is that the body of the sumps is not able to be grounded to dissipate static charges and the static build-up due to the fact of its non-conductive construction and materials.

A secondary containment system typically includes a primary pipeline in which a product such as gasoline flows from an underground storage tank to a product dispenser, and a secondary pipeline that surrounds the primary pipeline. The secondary pipeline is functioned to contain any fluid that may leak from a damaged primary pipeline, and prevent the fluid from contaminating the surrounding ground. The secondary pipeline is generally monitored for fluid collection so that any leak in the primary pipeline can be repaired promptly.

A typical secondary containment system also includes one or more sumps beneath equipment such as petroleum or diesel product dispensers. Product pipelines extend through the walls of such sumps to pipe fittings which connect the primary pipelines to the product dispensers/pump and or submersible turbine pumps. Such sumps are designed to contain any product which may leak from faulty fittings or pipelines.

Generally, gasoline flows at a rate of more than 1 m/s in the primary pipe causing electro static build up and therefore present a possible fire hazard. Further to this, all work carried out in the sumps by workmen that may introduce or increase the probability of brush discharges or electro static discharges, will be further reduced or eliminated as the conductive sumps by itself is safely grounded at all times.

Therefore, there exist a need to be able to overcome the potential fire hazards and risks that are present during installation and routine maintenance works carried out in these sumps.

The invention clearly addresses these needs by dissipating static build up, from fuel flow, brush discharges, work performed and or any form of activity that may induce static charge within the sumps, via the earth block, through the walls of the conductive sumps and into the ground.

U.S. Pat. No. 7,159,573 discloses a fuel feed apparatus which fuel is supplied into a sub tank by a jet pump and sucked by a fuel pump to be discharged. The fuel feed apparatus disposed in a fuel tank comprises: a sub tank included in the fuel tank; a fuel pump, included in the sub tank, for sucking fuel in the sub tank so as to discharge the fuel sucked from the sub tank; a jet pump having a jet nozzle for generating suction pressure by jetting fuel, the jet pump being for sucking fuel in the fuel tank by the suction pressure generated by the jet nozzle so as to supply the fuel sucked in the fuel tank to the sub tank, the jet nozzle being conductive; and a grounding terminal in the sub tank. The jet nozzle is being grounded via the grounding terminal, a case that surrounds the fuel pump, wherein the case and the fuel pump are substantially horizontally disposed in the sub tank, the grounding terminal is provided on a lateral side of the case, and the grounding terminal is located on a side of a bottom surface of the sub tank with respect to a central axis of the case.

U.S. Pat. No. 7,225,664 discloses a system for detecting a leak in a double-walled fuel piping having an outer annular space that carries fuel from an underground storage tank in a service station environment, comprising: a pressure sensor that is coupled to the outer annular space to detect a vacuum level in the outer annular space; a sensing unit controller that is coupled to said pressure sensor to determine the vacuum level in the outer annular space; a submersible turbine pump that is fluidly coupled to the fuel in the underground storage tank to draw the fuel out of the underground storage tank wherein said submersible turbine pump is also coupled to the outer annular space; said submersible turbine pump creates a vacuum level in the outer annular space wherein said sensing unit controller determines the vacuum level in the outer annular space using said pressure sensor; a controller that is electrically coupled to said submersible turbine pump wherein said submersible turbine pump creates a defined initial threshold vacuum level in the outer annular space after receiving a test initiation signal from the controller, wherein the controller is electrically coupled to said sensing unit controller to receive the vacuum level in the outer annular space; and a float liquid detection sensor that is coupled to the outer annular space. The float liquid detection sensor is coupled to said sensing unit controller and wherein said float liquid detection sensor detects if liquid is present in the outer annular space.

Thus a type of tank sump and dispenser sump which sets out with improved features such as fully conductive in the ground is desirable.

### SUMMARY OF THE INVENTION

One aspect of the present invention is to provide an improved tank sump and dispenser sump for fueling or refueling facilities which is fully conductive through underground comprising (a) a tank wall made from fiberglass composition impregnated with conductive resin; (b) an earth block secured at the inner surface of the tank; (c) a plurality of pipes mounted through holes provided on the wall of the tank; (d) a plurality of grounding cables connecting to the pipes and or any isolated conductor that needs to be grounded to the ground block fitted on the wall of the sumps.

In accordance with one aspect of the present invention, there is provided a method of earthing or grounding process for a conductive tank sump and dispenser sump for fueling or refueling facilities mounted with a ground block and a plurality of gasoline pipes to safe discharge of electrostatic comprising the steps of: (a) connecting grounding cables to the gasoline pipes and or isolated conductors which needs to be grounded located within the capacity of the sumps; (b) attaching the earthing or grounding cables to the ground block mounted or integrated on the inner wall of the tank sumps.

Conveniently, the present invention provides a dispenser sump and tank sump for fueling or refueling facilities which are constructed with a full fiberglass composition impregnated with a fully conductive resin compound which enables the sumps to achieve a fully conductive state. The conductive state measures below 10 M Ohms through the inside to outside surface of the wall of the sumps.

The sumps are provided with an earth block directly located to the wall of the sumps. The earth block is grounded by way of the fully conductive sumps that are installed in the ground. All grounding wires or cables of the pipes, accessories and or isolated conductors are directly attached via the earth block to complete the grounding process of the system.

Advantages of the present invention are that the tank sump and dispenser sump which is fully conductive eliminates the need to have a separate/external source of grounding, and the grounding cable connected via a ground block reduces hazard due to static electricity.

Another further advantage of the present invention is that all work carried out in the sumps by technicians that possibly introduce or increase the probability of brush discharges or electro static discharges will be further reduced or eliminated as the conductive sump by itself is safely grounded at all times.

An advantage of an embodiment of the present invention is to provide an earthing process which seeks to encompass a total safe operating solution incorporating the total overview of a fueling system from storage tanks to nozzle.

### BRIEF DESCRIPTION OF THE DRAWINGS

A detailed description of the preferred embodiment is provided herein below with reference to the following drawings, in which like numbers refer to like elements. The drawings are:

FIG. 1, in a schematic, exploded sectional view, illustrates a tank sump in accordance with a preferred embodiment of the present invention;

FIG. 2, in a schematic, exploded sectional view, illustrates a dispenser sump in accordance with the present invention;

FIG. 3 illustrates schematically the position of the tank sump and dispenser sump in accordance with a preferred embodiment of the present invention.

FIG. 4 illustrates schematically of the tank sump mounted with filing pipe and product pipe in accordance with the present invention, wherein FIGS. 4A and 4A′ show the top view of the tank sump and FIGS. 4B and 4B′ show the sectional view of the tank sump, wherein FIG. 4A and FIG. 4B illustrate a typical pressure system tank sump and FIG. 4A′ and FIG. 4B′ illustrate a typical suction system tank sump.

FIG. 5 is a sectional view showing the dispenser sump in accordance with the present invention.

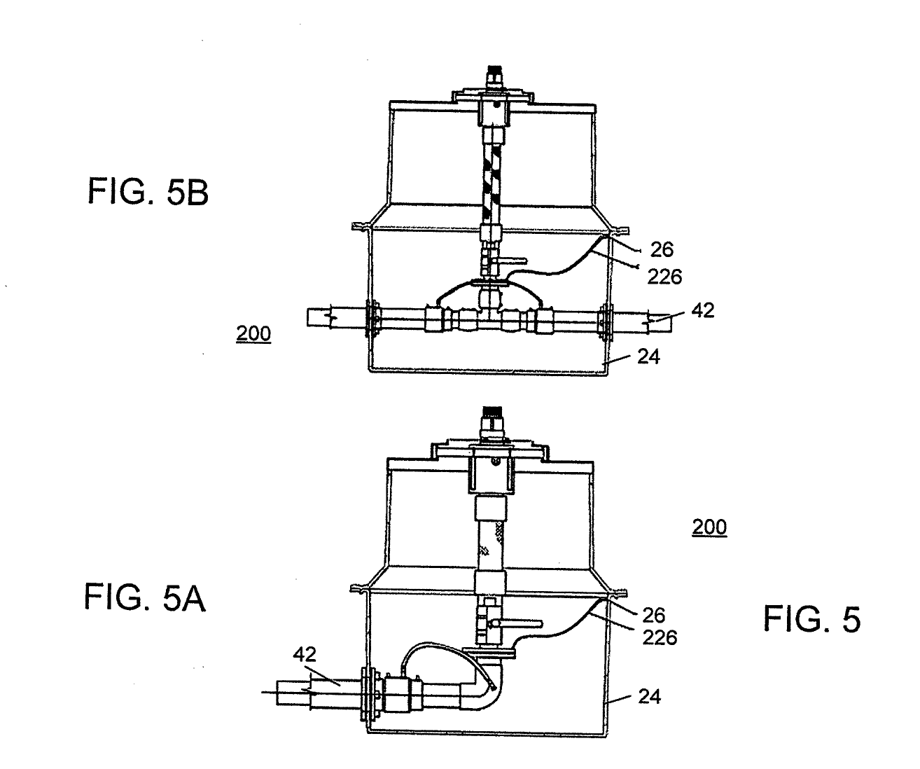

FIG. 6, in a sectional view, illustrates the wall of the sumps in accordance with the present invention.

### DETAILED DESCRIPTION OF THE PREFERRED EMBODIMENT

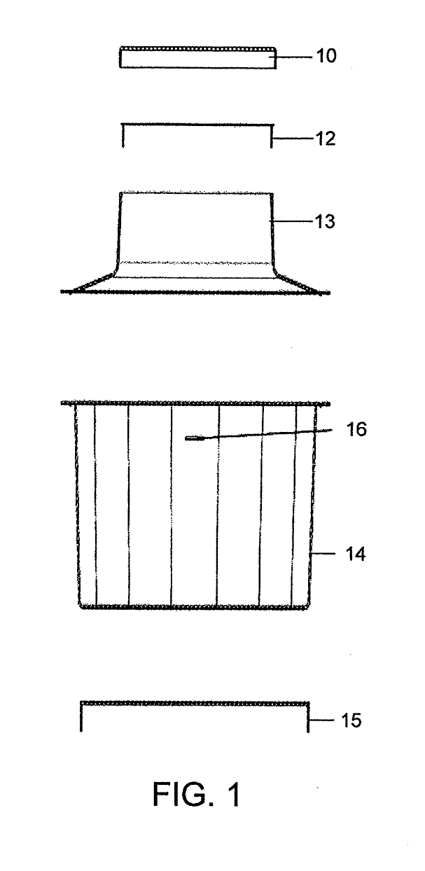

Referring to FIG. 1, there is shown a tank sump (100) of the present invention comprising a hollow base member (14), an upper portion (13), a top lip (12) and a top cover (10). A lower lip (15) is located below the hollow base member (14). On the inner wall of the hollow base member (14) is a grounding block (16) which is a conductor made from any conductive material.

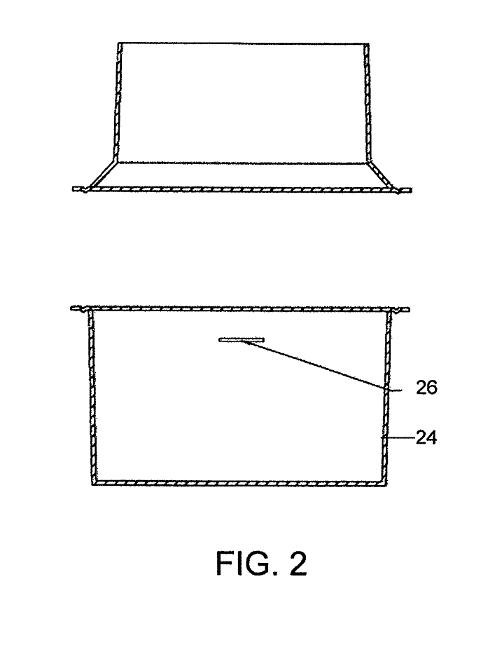

FIG. 2 illustrates a sectional view of a dispenser sump (200) of the preferred embodiment in accordance with the present invention. The dispenser sump (200) comprises a hollow base member (24), which could be of any shapes, and an upper portion (23) mounted onto the top of the base member (24), wherein a grounding block (26) is positioned at the internal wall of the base member (24). Similar to the grounding block (16) fitted to the base member (14) of the tank sump, the grounding block (26) of the dispenser sump (200) is a conductor, which is made from conductive material.

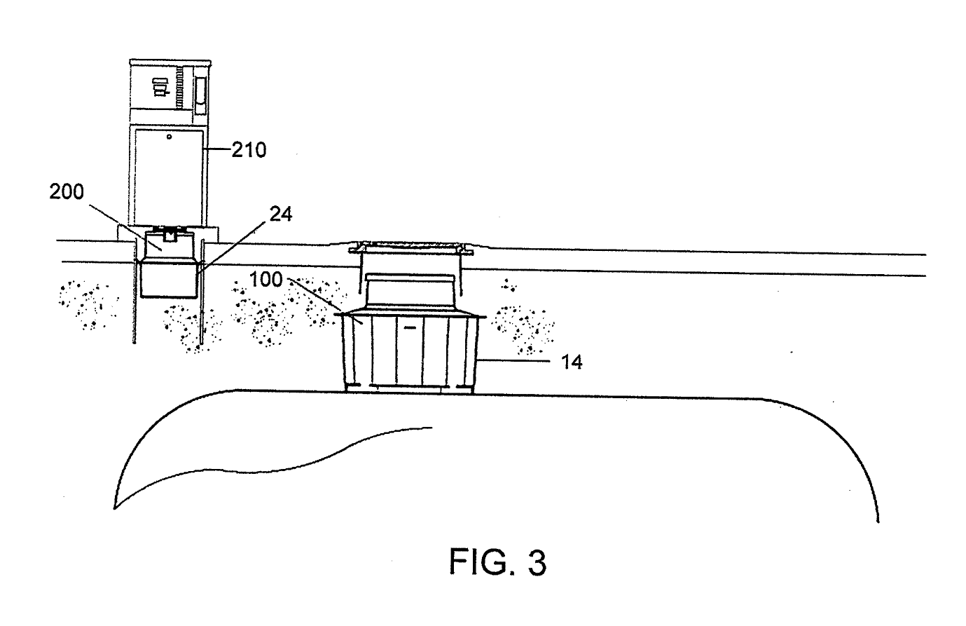

Referring to FIG. 3, there is shown schematically the relative position of the tank sump (100) and the dispenser sump (200) in the vicinity of a petroleum service station. A pump system (210) for gasoline is positioned above the dispenser sump (200) and a piping system (not shown) supplies gasoline to the dispenser sump (200). As shown schematically in FIG. 3, in the preferred embodiment, the tank sump (100) is positioned underground and the hollow base member (24) of the dispenser sump (200) is partial below the ground level.

Again, referring to FIGS. 1-3, the tank sump (100) and the dispenser sump (200) are constructed from a full fiberglass composition impregnated with a fully conductive resin compound which enables the sumps to achieve a fully conductive state. In accordance with one preferred embodiment of the present invention, the compositions of the fiberglass include chopped strand mat, ranging from 350-450 gm/m²; woven roving, ranging from 300-400 gm/m², coremat 1-3 mm, and surface tissue mat. The resin used in the preferred embodiment is prepared by removing a percentage of fillers, i.e., silica fumes and replacing with a percentage mixture of conductive fillers, for instance, carbon and or graphite fillers. Similarly the conductive gelcoat is prepared as above.

Conductive gelocoat is painted, sprayed or applied on to the mould surface, once cure is achieved, several layers of the composition materials are layered one at a time together with conductive resin following the lamination schedule provided.

The lay-up of the conductive resin and glass materials are carried out at a slower than standard pace in order to allow the various layers of conductive resin and glass mixture to obtain a full cure. The composition in accordance with the present invention allows a conductive measure of below 10 M Ohms to pass through the inner to other surfaces of the sumps (100, 200), thereby discharging static electricity. In accordance with a preferred embodiment of the present invention, the tank sump (100) or dispenser sump (200) is lightweight design, and provides solutions for water ingress into the sumps (100, 200). The sumps (100, 200) comprise (a) a tank wall made from fiberglass composition impregnated with conductive resin; (b) a grounding block (16, 26) secured at the inner surface of the tank sump/dispenser sump (100, 200); (c) a plurality of pipes mounted through holes provided on the wall of the tank sump/dispenser sump (100, 200); (d) a plurality of grounding cables (116, 226) connecting the pipes and/or isolated conductors which needs to be earthed to the ground block (16, 26) on the wall of the tank sump/dispenser sump (100, 200).

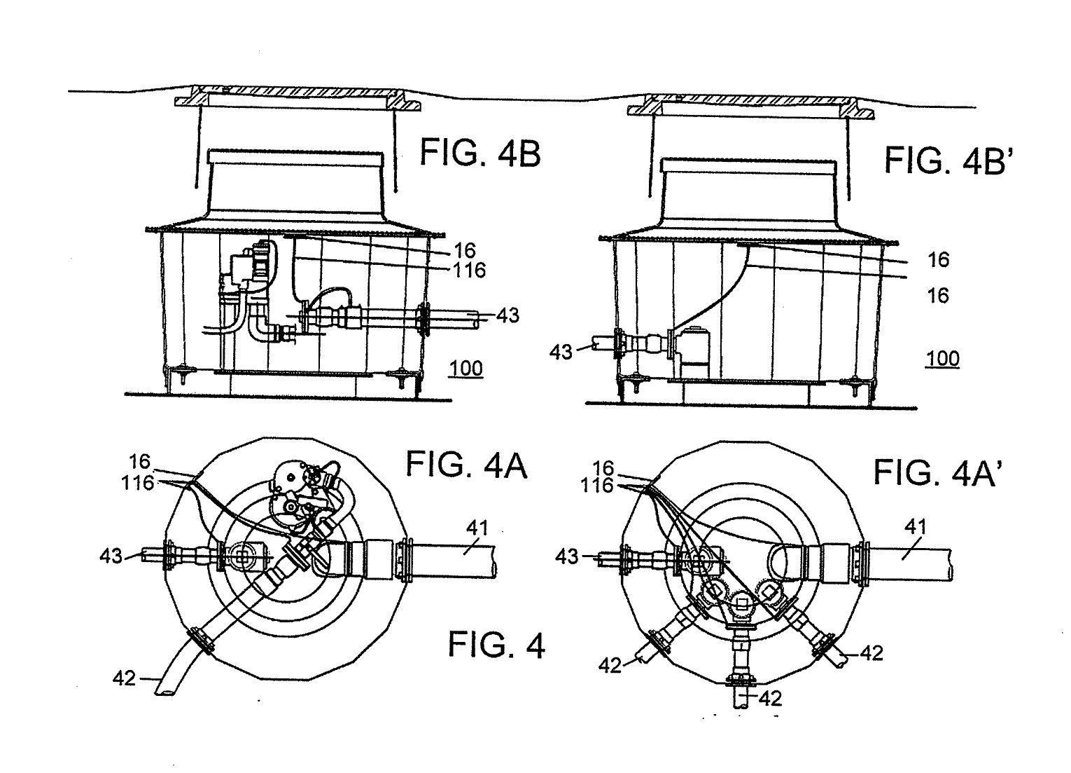

Referring to FIG. 4, there is shown schematically piping system within the cavity of the tank sump (100). FIG. 4A shows a typical pressure system type of tank sump (100) and FIG. 4A′ shows a typical suction system type of tank sump (100). FIGS. 4B and 4B′ are schematic sectional view of the tank sump (100) for typical pressure system type and typical suction system type. As shown in FIG. 4, a filing pipe (41) is mounted to the tank sump (100), and a vent pipe (43) is positioned to the tank sump (100) at one side opposite to that of the filing pipe (41). One or more than one product pipe (42) is/are mounted to the tank sump (100). As shown in the figures, a plurality of grounding cables (166) connect the front end of the product pipes (42), the front end of the vent pipe (43) and the front end of the filing pipe (41) to the ground block (16) mounted at the inner wall of the tank sump (100).

Similarly, referring to FIG. 4, there is shown the grounding of the dispenser sump (2) of the present invention. A grounding cable (226) connects the product pipe (42) to the ground block (26) fitted at the inner wall of the dispenser sump (200).

Again, referring to FIG. 1, the tank sump (100) has a wide sump opening, providing a bigger space for installation inside the sump (100) and work space during routine maintenance inside the sump (100). The wall of the sump (100) is preferred to be in a thickness of at least 9 mm throughout the whole sump (100) surface, offering superior structural strength with one-piece rigid construction of fiber-composite materials. A top sight-glass (optional, not shown in the figure) is provided on the cover (10) of the tank sump (100), providing a visibility into the tank sump (100) without opening the cover (10) and therefore, it facilitates routine inspection by operator of the fueling or refueling facilities.

The tank sump (100) has a special feature such as direct lamination to tank manway collar, tank sump lower lip insert and superior watertight gasket inserts at the cover (10) and will ensure that the cover (10) remain watertight when it is closed. The tank sump (100) also has a flexible lower flange which will ensure a perfect installation of the tank sump (100) onto the tank collar without any possibilities of tank sump cracks or swollen sections which will normally enable water to seep into the tank sump (100). The sump top lip insert is specially designed to ensure a total flat surface when the collar of the sump is field adjusted to the required height. The flat surface ensures a perfect fitment on the cover (10) and provides water tightness.

The tank sump (100) is built with a ground block (16) as mentioned earlier which is a special feature to ensure a full conductivity of the piping system (41, 42, 43) and or any isolated conductors, providing a solution for a safe working environment in the tank sump (100).

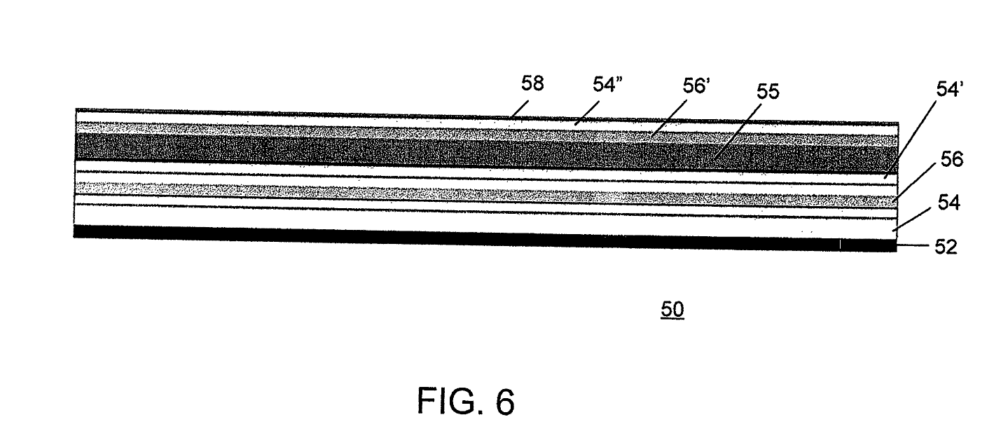

In this embodiment, as shown in FIG. 6, there is shown a sectional view of the wall of the tank sump (100) and of the dispenser sump (200), respective depicted in FIG. 1 and FIG. 2. There shown the wall (50) of an outermost layer, which is the conductive gelcoat (52), a chopped strand mat (54), a woven roving (56), a second chopped strand mat (54′), a core mat (55), a second woven raving (56′), a third chopped strand mat (54″) and finally a tissue mat (58).

In a preferred embodiment, the weight of the chopped strand mat (54) is 450 gm/m², and that of the woven roving (56) is 400 gm/m², and the thickness of the coremat (55) is 3 mm.

A conductive resin composition is used for the fabrication of all the layered mentioned above. The resin used is specifically prepared by removing a percentage of fillers, i.e., silica fumes and replacing with a percentage mixture of conductive fillers, e.g., carbon and or graphite fillers. In the present invention, the conductive resin comprises equal to or greater than 1.5% by weight of carbon and or graphite.

The gelcoat composition (52) is prepared by removing a percentage fillers, i.e., silica fumes and wax additives. Thereafter, a percentage mixture of conductive fillers, e.g., carbon and or graphite fillers are added. In a preferred embodiment, the gelcoat contains carbon and/or graphite filler equal to or greater than 1.5% by weight.

Other variations and modifications of the invention are possible. For example, wall of the tank could be made out of different composition and components, and/or the ground block (16, 26) could be mounted to the wall of the tank sump (100)/dispenser sump (200) at various position there.

While one embodiment of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto.

1. A tank sump (100) and dispenser sump (200) for fueling or refueling facilities which is fully conductive through underground comprising
(a) a sump wall made from fiberglass composition impregnated with conductive resin;
(b) a ground block (16, 26) secured or integrated at the inner surface of the tank sump/dispenser sump (100, 200);
(c) a plurality of pipes (41, 42, 43) mounted through holes provided on the wall of the tank sump/dispenser sump (100, 200); and
(d) a plurality of grounding cables connecting the pipes and/or isolated conductors which needs to be earthed to the ground block (16, 26) on the wall of the tank sump/dispenser sump (100, 200).

2. The tank sump (100) and dispenser sump (200) according to claim 1, wherein conductive resin comprises equal to or greater than 1.5% by weight of carbon and or graphite

3. The tank sump (100) and dispenser sump (200) according to claim 1, wherein the sumps is either fully or partially buried in the ground to dissipate any static electricity built up on the surface of the sumps.

4. A method of grounding process for a conductive tank sump (100) and dispenser sump (200) mounted with a ground block (16, 26) and a plurality of gasoline pipes to safe discharge of electrostatic comprising the steps of:
(a) connecting grounding cables (116, 226) to the gasoline pipes located within the capacity of the of tank sump/dispenser sump (100, 200);
(b) attaching the grounding cables (116, 226) to the ground block (16, 26) mounted on the inner wall of the tank sump/dispenser sump (100, 200).

5. The method of claim 4, wherein the static electricity built up on the tank sump/dispenser sump (100, 200) is conductively earthed in the ground, thereby eliminating static charge.

6. The tank sump (100) and dispenser sump (200) according to claim 1, wherein the sump is positioned below ground level but keeps away ground water.

7. The tank sump (100) and dispenser sump (200) according to claim 1, wherein the wall of the tank sump (100) and the dispenser sump (200) comprises a chopped strand mat (54), a woven roving layer (56), a coremat layer (55), tissue mat (58) and a conductive gelcoat (52) which is fabricated with the conductive resin composition.

8. The sumps according to claim 1, wherein the conductivity of the wall is below 10 M Ohms.

9. The method according to claim 4, wherein electrostatics developed on the wall of the tank sump (100) and/or dispenser sump (200) are dissipated to the ground.

10. The method according to claim 4, wherein electrostatics developed on the pipes are dissipated to the ground via the grounding cable to the grounding block (16, 26) mounted to the wall of the tank sump (100) and/or dispenser sump (200).

11. The tank sump (100) and dispenser sump (200) according to claim 7, wherein the weight of the chopped strand mat is 450 gm/m².

12. The tank sump (100) and dispenser sump (200) according to claim 7, wherein the weight of the woven roving is about 400 gm/m².

13. The sumps according to claim 7, wherein the thickness of the coremat is about 3 mm.

14. The sumps according to claim 7, wherein the gelcoat contains carbon and or graphite filler equal to or greater than 1.5% by weight.
